(19) United States
(12) Patent Application Publication
(10) Pub. No.: US 2003/0057032 A1
(43) Pub. Date: Mar. 27, 2003

(54) Bicycle brake

(76) Inventor: Jen-Chih Liu, Kaohsiung (TW)

Correspondence Address: PRO-TECHTOR INTERNATIONAL, 20775 Norada Court, Saratoga, CA, 95070-3018, US

(21) Appl. No.: 09/965,192

(22) Filed: Sep. 25, 2001

(51) Int. Cl. B62L 1/02

(52) U.S. Cl. 188/24.12; 188/24.11

(57) ABSTRACT

Bicycle brake including a brake mechanism and several brake blocks disposed in the brake drum and the hub cover. The brake mechanism includes a power disc driven by the brake cord, a pressure adjustment ring, an equalizer and at least one linking member. The power disc drives at least one linking member to displace and outward push the brake block to contact with the brake drum for creating a first stage of braking effect. When the power disc further rotates and the rotational force is greater than the set resilient pressure value of the resilient member between the equalizer and the pressure adjustment ring, the resilient member is collapsed, whereby the linking member is rotated and displaced to strongly outward push the brake block and further create a second stage of braking effect.

### BACKGROUND OF THE INVENTION

The present invention is related to an improved bicycle brake, and more particularly to a two-stage lockproof brake system of a bicycle.

In a conventional bicycle or motorcycle drum-type brake system, a brake cord is used to outward shift the brake block in the brake drum for abrading the brake drum so as to achieve a braking effect. In actual use, due to improper operation and sudden reaction of the user, the brake is often instantaneously locked. This will result in slippage of the wheel or even falling of the bicycle or motorcycle. Therefore, when instantaneously urgently braking the bike, the brake is often instantaneously locked by the abrupt and excessively great braking force.

In order to solve the problem of slippage of the wheel resulted from instantaneous locking of the brake, the car is equipped with a lockproof brake system. However, there is still no lockproof brake system developed for bicycles and motorcycles.

### SUMMARY OF THE INVENTION

It is therefore a primary object of the present invention to provide an improved bicycle brake in which the two-stage braking effect is truly enhanced.

It is a further object of the present invention to provide the above bicycle brake in which the balanced pressure setting of the first stage of buffering braking force is enhanced and the manufacturing of the components is facilitated.

It is still a further object of the present invention to provide the above bicycle brake in which when second stage of braking force is required, the second stage of braking effect is strongly created. Therefore, when normally braked or emergently braked, the brake system is prevented from being locked so that the safety can be ensured and the braking effect can be quickly achieved.

The present invention can be best understood through the following description and accompanying drawings wherein:

### BRIEF DESCRIPTION OF THE DRAWINGS

FIG. 1 is a perspective exploded view of the present invention;

FIG. 2 shows the pressure adjustment ring of the present invention;

FIG. 3 is a right view according to FIG. 2;

FIG. 4 shows the equalizer of the present invention;

FIG. 5 is a right view according to FIG. 4;

FIG. 6 is a top view according to FIG. 4;

FIG. 7 shows the power disc of the present invention;

FIG. 8 is a right view according to FIG. 7;

FIG. 9 is a top view according to FIG. 7;

FIG. 10 shows the linking member of the present invention;

FIG. 11 is a right view according to FIG. 10;

FIG. 12 is a top view according to FIG. 10;

FIG. 13 shows the present invention in a still state;

FIG. 14 shows the first stage of braking operation of the present invention; and

FIG. 15 shows the second stage of braking operation of the present invention.

### DETAILED DESCRIPTION OF THE PREFERRED EMBODIMENTS

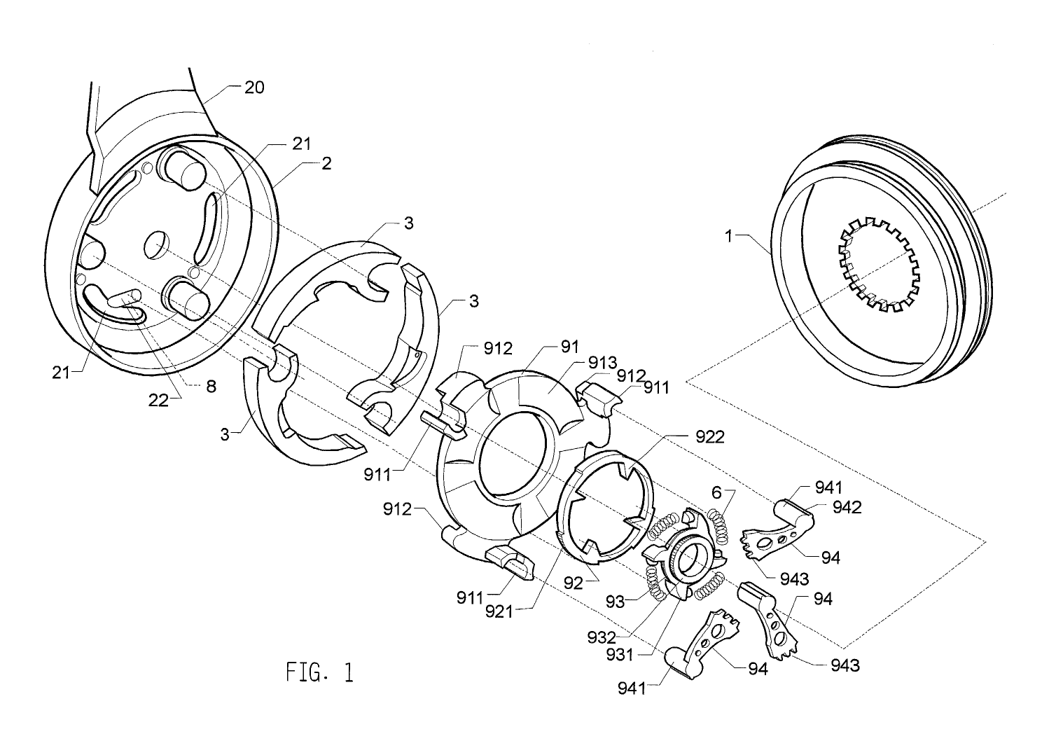

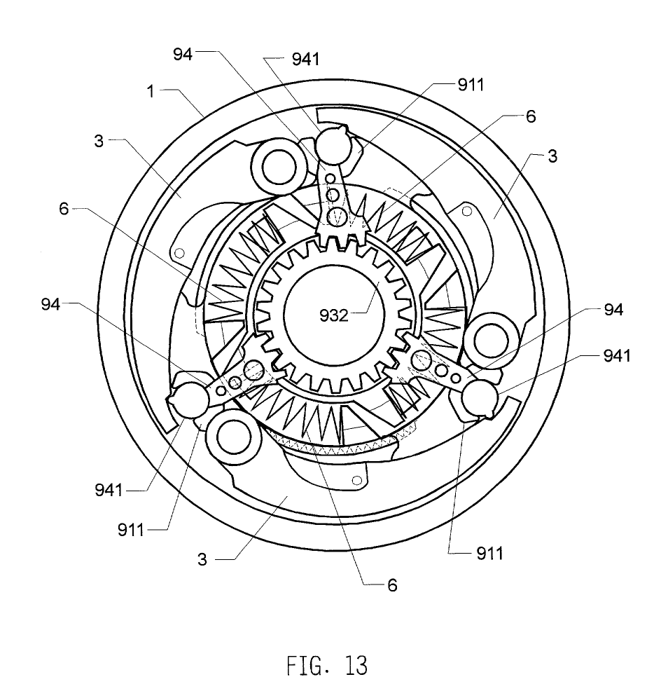

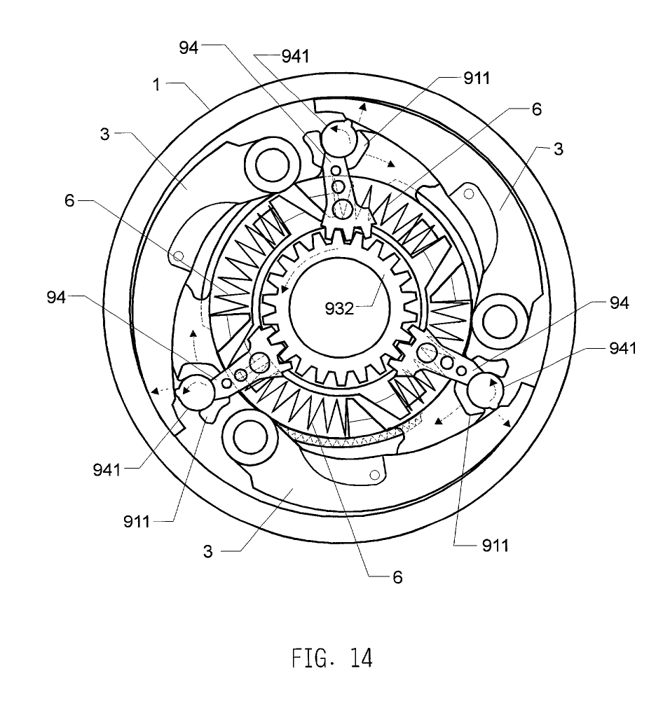

Please refer to FIG. 1. A brake drum 1 assembled with the hub is mated with a hub cover 2 fixed on the bicycle frame by a brake arm 20. A brake mechanism and several brake blocks 3 are disposed in the brake drum 1 and the hub cover 2. The brake mechanism includes a power disc 91 (as shown in FIGS. 1 and 7 to 9) driven by the brake cord, a pressure adjustment ring 92 (as shown in FIGS. 1 to 3), an equalizer 93 (as shown in FIGS. 4 to 6) and at least one linking member 94 (as shown in FIGS. 10 to 12). The power disc 91 drives at least one linking member 94 to displace and outward push the brake block 3 to contact with the brake drum 1 for creating a first stage of braking effect (as shown in FIG. 13). When the power disc 91 further rotates and the rotational force is greater than the set resilient pressure value of the resilient member 6 between the equalizer 93 and the pressure adjustment ring 92, the resilient member 6 is forcedly collapsed, whereby the linking member 94 is rotated and displaced to strongly outward push the brake block and create a second stage of braking effect (as shown in FIG. 14). Accordingly, a two-stage safe braking effect is achieved to avoid instantaneous locking of the brake.

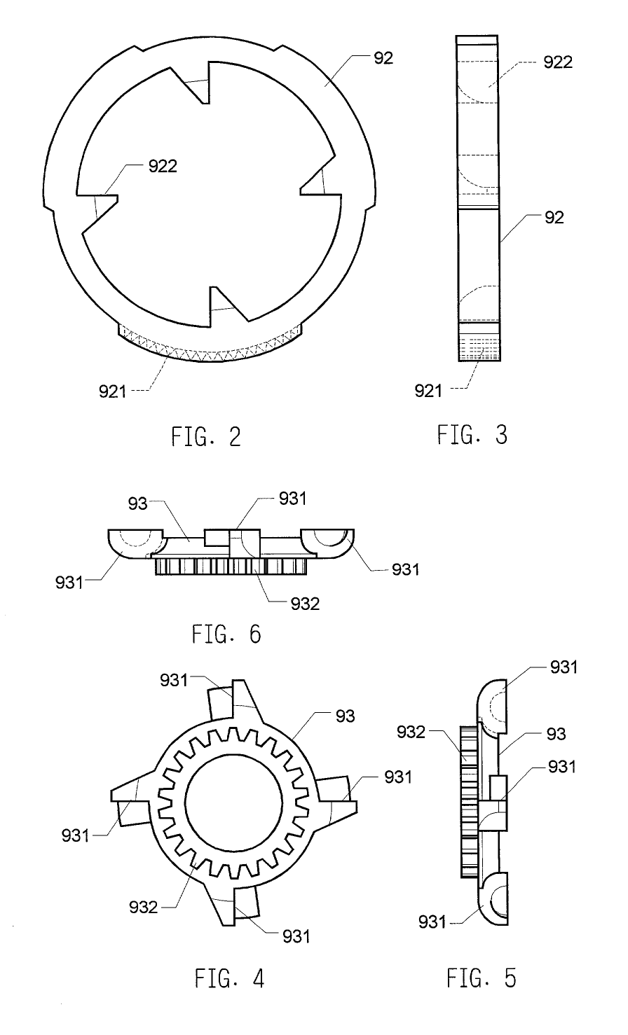

Referring to FIGS. 2 and 3, the outer circumference of the pressure adjustment ring 92 is formed with toothed face 921 engaged with angle setting pin 8 disposed at the adjustment hole 22. The inner circumference is formed with projections 922 the number of which is equal to that of the resilient members 6. One end of the resilient member 6 abuts against the projection 922.

FIGS. 4 to 6 show the equalizer 93 cooperating with the pressure adjustment ring 92. The outer circumference of the equalizer 93 is formed with projections 931 the number of which is equal to that of the resilient members 6. The other end of the resilient member 6 abuts against the projection 931. One side of the equalizer 93 is provided with an engaging gear 932 for engaging with the toothed face 943 of bottom end of the linking member 94.

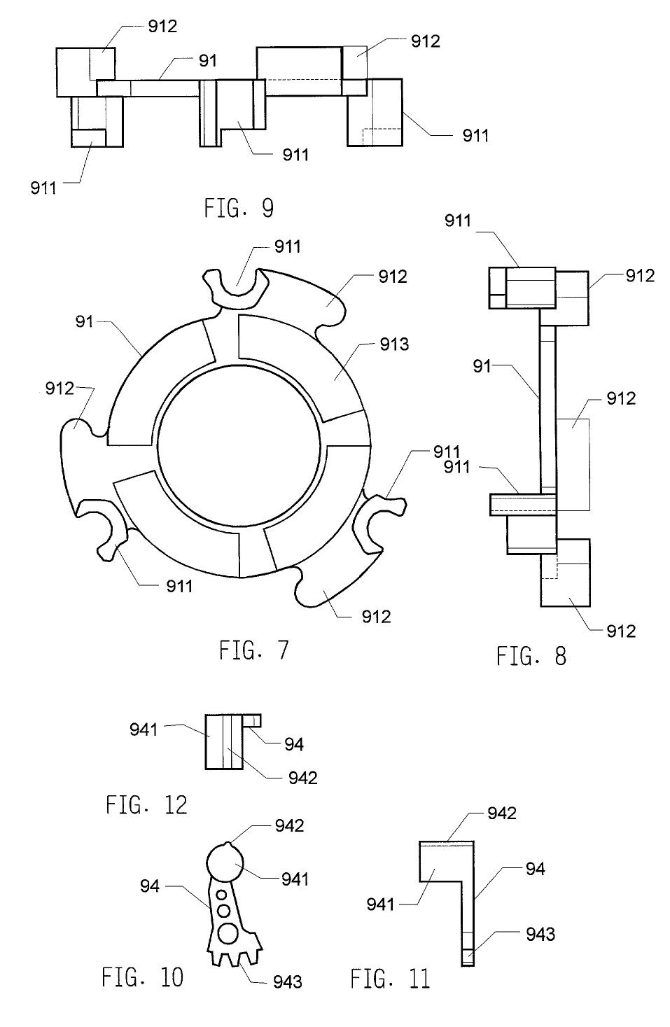

Referring to FIGS. 7 to 9, the outer circumference of the power disc 91 is formed with multiple projecting receiving seats 911. The abutting section 941 of top end of the linking member 94 is located on the receiving seat 911. The receiving seat 911 laterally extends from one side of the power disc 91. The other side is formed with a reversely projecting linking block 912. After assembled, the linking block 912 protrudes from the opening 21 of the hub cover 2 to be driven by external force (brake cord). A lateral face of the power disc 91 is formed with multiple recessed curved faces 913 for escaping the resilient members 6.

Referring to FIGS. 10 to 12, the top end of the linking member 94 has a transverse beam-type abutting section 941 located in the receiving seat 911 of the power disc 91. A projecting section 942 is omissibly disposed on the abutting section. The bottom end of the linking member is formed with a toothed face 943 for drivingly engaging with the engaging gear 932 of the equalizer 93 so as to transmit the reaction force between the abutting section 941 and the brake block 3 to the resilient member 6 and receive the pressure equalizing force provided by resilient member 6 via the equalizer 93 in a not braked state (as shown in FIG. 13).

Referring to FIG. 14, when external force (brake cord) drives the power disc 91 to rotate, the power disc 91 via the receiving seat 911 urges the abutting section 941 of the linking member 94 to outward push the brake block 3 to create a first stage of buffering braking effect. (That is, when braked, the reaction force between the abutting section 941 of the linking member 94 and the brake block 3 is not greater than the set pressure balancing value of the resilient member 6.

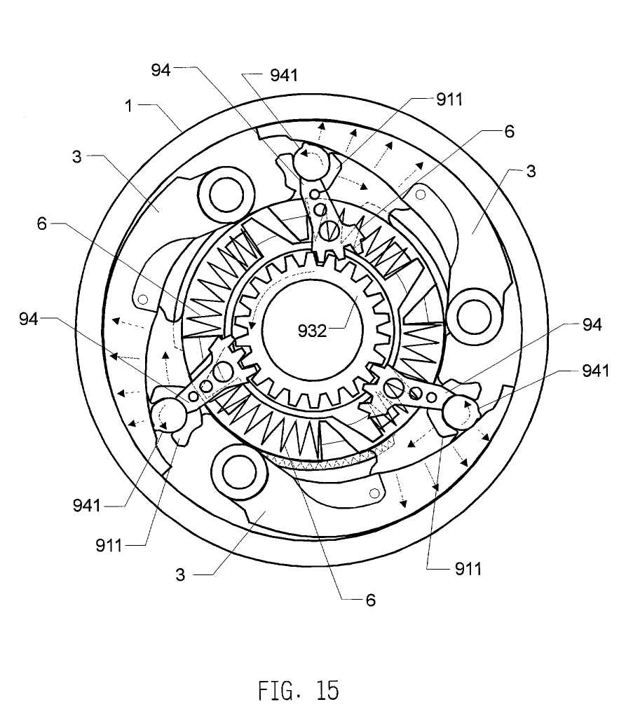

Referring to FIG. 15, when the external force (brake cord) makes the power disc 91 further rotate, the reaction force between the abutting section 941 of the linking member 94 and the brake block 3 is greater than the set pressure balancing value of the resilient member 6. At this time, due to collapse of the resilient member 6, the power disc 91 via the receiving seat 911 urges the equalizer 93 to reversely move. Therefore, the linking member 94 rotates to outward push the brake block and create a strong second stage of safe braking effect.

The present invention has the following advantages:

1. The reaction of two-stage lockproof brake system is truly enhanced so that the braking is more stable and safer.

2. The balanced pressure setting of the resilient member is effectively provided and the manufacturing is facilitated.

3. The quality and safety of two-stage lockproof bicycle brake system is truly enhanced.

4. The operation is speeded and the accuracy of the operation is enhanced.

5. The production efficiency is promoted and the power transmission is simplified.

The above embodiments are only used to illustrate the present invention, not intended to limit the scope thereof. Many modifications of the above embodiments can be made without departing from the spirit of the present invention.

What is claimed is:

1. Bicycle brake comprising a brake drum assembled with the hub and a hub cover fixed on the bicycle frame by a brake arm and mated with the brake drum, a brake mechanism and several brake blocks being disposed in the brake drum and the hub cover, the brake mechanism including a power disc driven by the brake cord, a pressure adjustment ring, an equalizer and at least one linking member, the power disc driving at least one linking member to displace and outward push the brake block to contact with the brake drum for creating a first stage of braking effect, when the power disc further rotates and the rotational force is greater than the set resilient pressure value of the resilient member between the equalizer and the pressure adjustment ring, the resilient member being forcedly collapsed, whereby the linking member is rotated and displaced to strongly outward push the brake block and create a second stage of braking effect.

2. Bicycle brake comprising a brake drum assembled with the hub and a hub cover fixed on the bicycle frame by a brake arm and mated with the brake drum, a brake mechanism and several brake blocks being disposed in the brake drum and the hub cover, the brake mechanism including a power disc driven by the brake cord, a pressure adjustment ring, an equalizer and at least one linking member, wherein:
an outer circumference of the pressure adjustment ring is formed with toothed face engaged with angle setting pin disposed at the adjustment hole of the hub cover, an inner circumference being formed with projections the number of which is equal to that of the resilient members, one end of the resilient member abutting against the projection;
the equalizer cooperates with the pressure adjustment ring, the outer circumference of the equalizer being formed with projections the number of which is equal to that of the resilient members, the other end of the resilient member abutting against the projection, one side of the equalizer being provided with an engaging gear for engaging with the toothed face of bottom end of the linking member;
the outer circumference of the power disc is formed with multiple projecting receiving seats, the abutting section of top end of the linking member being located on the receiving seat, the receiving seat laterally extending from one side of the power disc, the other side being formed with a reversely projecting linking block driven by external force; and
the top end of the linking member has a transverse beam-type abutting section located in the receiving seat of the power disc, a projecting section being omissibly disposed on the abutting section, the bottom end of the linking member being formed with a toothed face for drivingly engaging with the engaging gear of the equalizer.

3. Bicycle brake as claimed in claim 1, wherein the linking member via the equalizer transmits the reaction force between the abutting section and the brake block to the resilient member.

4. Bicycle brake as claimed in claim 2, wherein the linking member via the equalizer transmits the reaction force between the abutting section and the brake block to the resilient member.

5. Bicycle brake as claimed in claim 2, wherein a lateral face of the power disc is formed with multiple recessed curved faces for escaping the resilient members.
